(19) United States
(12) Patent Application Publication
(10) Pub. No.: US 2007/0000162 A1
(43) Pub. Date: Jan. 4, 2007

(54) Sign including rail with removable face

(76) Inventors: Donald T. Meeker, Larchmont, NY (US); Chris O'Hara, Yorktown Heights, NY (US); Eugene A. Avallone P. E., Ardsley, NY (US)

Correspondence Address: Alfred W. Froebrich, Esq.;Cohen, Pontani, Lieberman & Pavane, Suite 1210, 551 Fifth Avenue, New York, NY, 10176, US

(21) Appl. No.: 11/441,754

(22) Filed: May 26, 2006

Related U.S. Application Data
(60) Provisional application No. 60/685,622, filed on May 27, 2005.

(51) Int. Cl. G09F 7/00

(52) U.S. Cl. 40/611.05

(57) ABSTRACT

A sign system includes an upper rail and a lower rail, or upper and lower rail with one or more intermediate rails each extending between laterally-spaced vertical supports. Each of the upper rail and lower rail have a longitudinal groove running substantially along the longitudinal lengths thereof. The longitudinal grooves of the upper and lower rails are confrontingly opposed and each has a central portion with a length and lateral sides and side portions extending along the lateral sides of the central portion such that inner sides of the side portions face the lateral sides of the central portion and external sides of the side portions face away from the lateral sides of the central portion. A face plate is releaseably connected to one of the upper and lower rails. The face plate defines an outer side of one of said side portions of said longitudinal groove of said one of said upper and lower rails when said removable face is connected to said one of said upper and lower rail. Lateral access to the one of the side portions normal to said planar core piece is provided when said removable face is disconnected from the one of the upper and lower rails.

### BACKGROUND OF THE INVENTION

The present invention relates to a retainer for a sign system in which a sign is held between two horizontal rails with confrontingly opposed longitudinal channels.

U.S. Pat. No. 6,655,062 discloses a sign system having upper and lower rails affixed between two laterally spaced vertical posts, the upper and lower rails having channels in which the sign panels are received. These sign systems provide robust structures which are able to withstand large natural and deliberate destructive forces. However, it is not easy to replace or change information on a sign because removal of a panel typically requires that one of the rails be removed. Accordingly, it is not desireable to use such a sign system if frequent and/or periodic sign changes are required. To add utility to the design that will allow users to conveniently replace or change a panel using a rail removable face without the more complex process of removing a structural rail would be an optimal addition to the design. Accordingly, a more expedient removal mechanism is needed which allows the sign system disclosed in U.S. Pat. No. 6,655,062 to be used in applications that require periodic sign changes.

### SUMMARY OF THE INVENTION

According to the present invention, a sign panel includes two laterally spaced vertical supports with upper and lower rails connected therebetween. The upper and lower rails have confrontingly opposed longitudinal channels running substantially between first and second ends of the upper and lower rails. Each of the channels includes a central portion along a longitudinal length of the channel and side portions on either lateral side of the central portion. A substantially planar core piece having first and second planar sides and upper and lower edges is removably received in the central portion of the confrontingly opposed channels. A substantially rigid sign panel having an upper edge and a lower edge is receivable in first side portions of the confrontingly opposed channels on the first planar side of the core piece. One of the upper and lower retaining rails includes a face plate defining a side of the first side portion of the confrontingly opposed channel of the one of the upper and lower retaining rails. The faceplate is removable so that the sign panel may be removed from the first side portion without requiring disassembly of one of the upper and lower retaining rails while allowing the core piece to remain securely attached to both the upper and lower rails.

The removable face plate is connected to the one of the upper and lower rails by threaded fasteners. The one of the upper and lower rails may include threaded holes for receiving the threaded fasteners. Alternatively, the one of the upper and lower rails may include a continuous threaded groove for receiving the threaded fasteners. As yet a further alternative, the one of the upper and lower rails has a continuous channel for receiving a connector element for threadably receiving the threaded fasteners.

A first surface of the removable face plate slides over a second surface of the one of the upper and lower rails during connection or mounting of the removable face so that the removable face is properly aligned with the one of the upper and lower rails when it is received thereon and becomes an integral part of the composite rail structure when attached. The second surface extends in a direction normal to the core piece.

A depression may be arranged on the second surface corresponding to a projection on the first surface, wherein the projection engages the depression when the face plate is mounted on the one of the upper and lower rails.

A further face plate connected to the one of the upper and lower rails. The further face plate defines the external side of the other one of the side portions of the longitudinal groove of the one of the upper and lower rails when the removable face is connected to the one of said upper and lower rails. Lateral access to the other one of the side portions normal to the planar core piece is provided when the further removable face plate is disconnected from the one of the upper and lower rails.

The one of said upper and lower rails may be a central rail located at the bottom of an upper panel and at the top of a lower panel and have upper and lower longitudinal grooves. The face plate defines the external side of one of the side portions of each of the upper and lower longitudinal grooves of the one of the upper and lower rails when the removable face is connected. Lateral access to the one of the side portions of the each of the upper and lower longitudinal grooves normal to the planar core piece is provided when the removable face is disconnected. A further face plate may be arranged to define the external sides of the other side portions of the upper and lower longitudinal grooves of the one of the upper and lower rails when the removable face is connected to the one of the upper and lower rails. Lateral access to the other side portions normal to the planar core piece is provided when further removable face is disconnected.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a perspective view of a sign in which the present invention may be implemented;

FIG. 2 is an exploded perspective view of the sign of FIG. 1;

FIG. 3 is a front view of the sign of FIG. 1;

FIG. 4 is a side view of the sign along line IV-IV in FIG. 3;

FIG. 5 is a cross section of the sign in FIG. 3 along line V-V;

FIG. 6 is a perspective view of a upper retaining rail according of the sign in FIG. 1;

FIG. 7 is an exploded perspective view of a sign according to another embodiment;

FIG. 8 is a cross section of the sign in FIG. 7 along the line VIII-VIII;

FIG. 9 is an exploded perspective view of a center retaining rail according to the present invention which may be implemented in the sign of FIG. 7;

FIG. 10 is an end view of a face plate of the center retaining rail of FIG. 9;

FIG. 11 is an exploded view of another embodiment of the a center retaining rail with removable face plate;

FIG. 12 is an exploded view of yet another embodiment of the a center retaining rail with removable face plate;

FIG. 13 shows a further embodiment of a channel in a retaining rail;

FIG. 14 shows yet another embodiment of a channel in a retaining rail;

FIG. 15 is an exploded perspective view of a sign including a retaining rail according to an embodiment of the present invention;

FIG. 16 is a cross section of the sign in FIG. 15 along the line XVI-XVI;

FIG. 17 is a cross section of another embodiment of a sign according to the present invention;

FIG. 18 is an exploded view of a center rail from the sign of FIG. 17;

FIG. 19 is a sectional view of sign according to yet another embodiment of the present invention;

FIG. 20 is an exploded view of a rail used in the sign of FIG. 19;

FIG. 21 is a sectional view of a sign according to yet another embodiment of the present invention; and

FIG. 22 is an exploded view of a rail used in the sign of FIG. 21.

### DETAILED DESCRIPTION OF THE PRESENTLY PREFERRED EMBODIMENTS

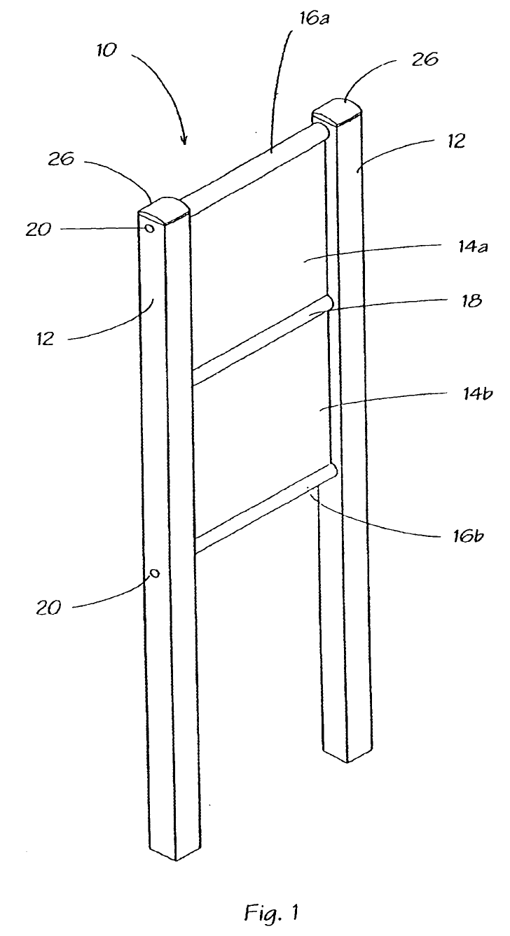

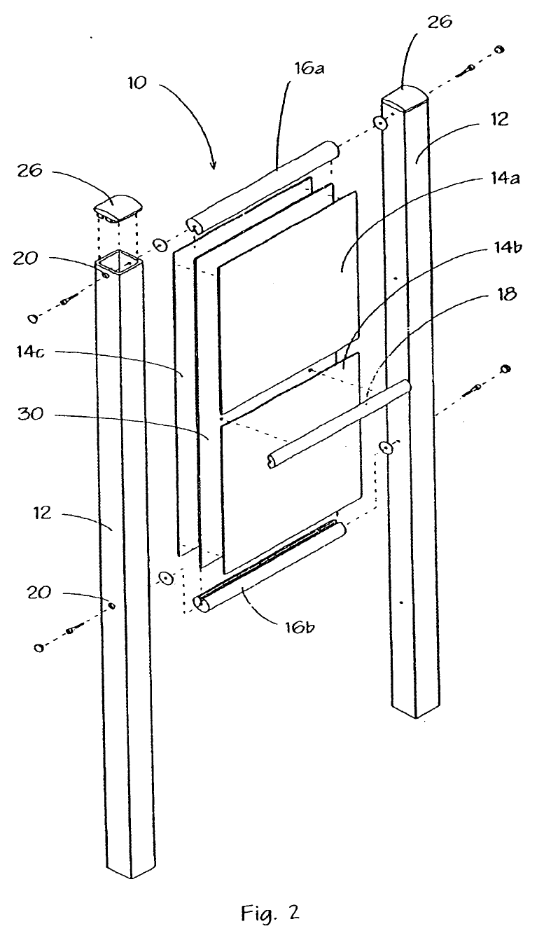

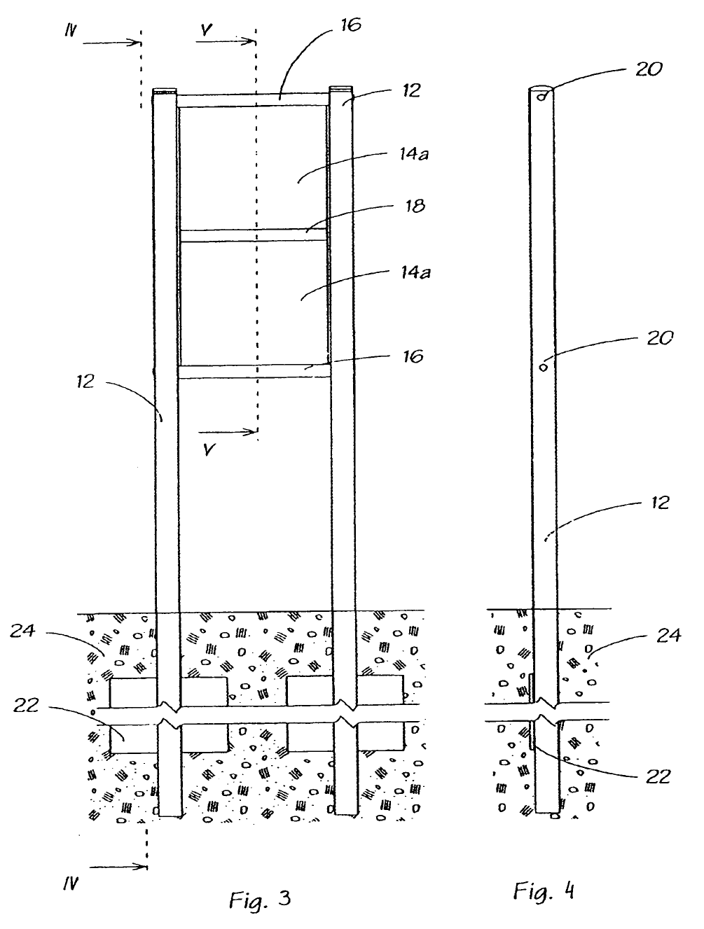

In the embodiment of the present invention shown in FIGS. 1-5, a sign system 10 is supported by vertical uprights 12. An upper retaining rail 16a and a lower retaining rail 16b are connected between the vertical uprights 12 to hold sign panels 14a, 14b. Holes 20 in the vertical uprights 12 provide access for mechanical fasteners, such as bolts and screws, (see FIG. 2) which hold the retaining rails 16a and 16b onto the vertical uprights 12. Alternatively, the vertical uprights 12 may be provided without the holes 20 so that the heads of the mechanical fasteners are exposed. If the retaining rails 16a and 16b and the vertical uprights 12 comprise dissimilar metals, non-conducting separators or washers may be used as shown in FIG. 2 which are smaller in diameter than the retaining rails 16a and 16b thereby preventing water from running between the post to the panels and inhibiting galvanic action from occurring between the dissimilar metals such as steel and aluminum. The holes 20 in the vertical uprights may be covered, plugged, or filled after the mechanical fasteners are connected to the inboard face of the vertical uprights 12 to deter vandalism. Mechanical fasteners with vandal resistant heads may be used to increase vandal resistance. A center retaining bracket 18 is used to separate and aid in holding the two side panels 14a, 14b that are positioned one on top of the other while allowing a taller panel to be placed on the opposite side of the core 30. The vertical uprights 12 are depicted as being substantially square in cross-section. However, vertical uprights 12 may have any cross-sectional shape. The vertical uprights do not require complex extrusions because retaining rails 16 are merely connected via a mechanical fastening device through a side of the vertical uprights 12. The vertical uprights 12, retaining rails 16, and retaining brackets 18 may be comprised of any material of suitable strength including, for example, plastics, metals such as aluminum, steels, metal alloys, and other high strength compounds and composites. Each vertical upright 12 also has a cap 26 which is held in place by a friction fit. Instead of a friction fit, any suitable attachment means may also be used such, for example, as adhesives, welding, and mechanical fasteners. In addition, cap 26 may also be formed integrally with vertical upright 12 instead of being a separate piece.

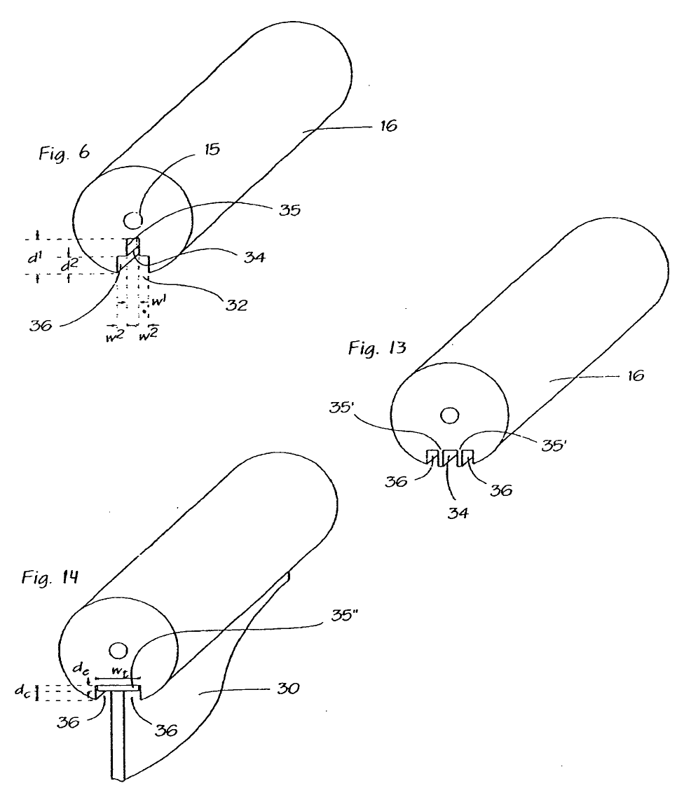

Referring now also to FIG. 6, which is a detailed perspective drawing of the upper retaining rail 16a, each of the retaining rails 16a and 16b has a longitudinal channel 32 including a center portion 34 and side portions 36 along either side of the center portion 34. The center portion 34 has a width w1 and a depth d1 and the side portions have widths w2 and depths d2. The upper and lower ends of a core 30 are inserted into the center portion 34 of channel 32 in retaining rails 16a and 16b. In this manner, the upper and lower retaining rails 16a and 16b and the core 30 form an I-beam in the installed state, wherein the core 30 is the web of the beam and the retaining rails 16a, 16b function as the flange.

The core 30 comprises a planar sheet of material of suitable stiffness, such, for example, as a ⅛″ thick aluminum plate, which is held between the retaining rails 16a and 16b. The core 30 reduces the vertical deflection of the retaining rails 16a, 16b by compression. Any weight exerted on the upper retaining rail 16a is distributed throughout the core 30 which provides support for the sign system so that the sign panels 14 are not easily damaged by deliberate destructive forces, i.e., vandalism, and natural destructive forces, such as, for example, the wind. The arrangement of the retaining rails 16a and 16b and core 30 provides a very strong but sheer backing for sign panels 14a, 14b, and 14c.

The sides of the center portion 34 of channel 32 form stops 35 which prevent the ends of the core 30 from entering the side portions 36 of the channel 32. After the core 30 is inserted in the center portion, the sign panels 14a, 14b, and 14c are then inserted into the side portions 36 of the retaining rails 16a and 16b, and the retaining rails 16a, 16b fixedly connected to the posts 12.

FIG. 6 shows a hole 15 which may be used to insert a non-conductive metal fastener (screw or bolt) to connect the retaining rail 16a (and 16b) to the uprights 12. The hole 15 is preferably threaded for detachably receiving a threaded connection element (not shown). Although, the upper and lower retaining rails 16a and 16b are preferably detachably connected to the posts 12 so that sign panels 14 may be replaced, the upper and lower retaining rails 16a and 16b may also be fixedly connected to the posts 12 by threaded mechanical fasteners, high strength adhesives, and/or sheer pins. In addition, FIG. 6 depicts the upper retaining rail 16a as having a circular cross section. However, the upper and lower retaining rails 16a and 16b may have any cross sectional shape that accommodates the channel 32 while maintaining the structural integrity required.

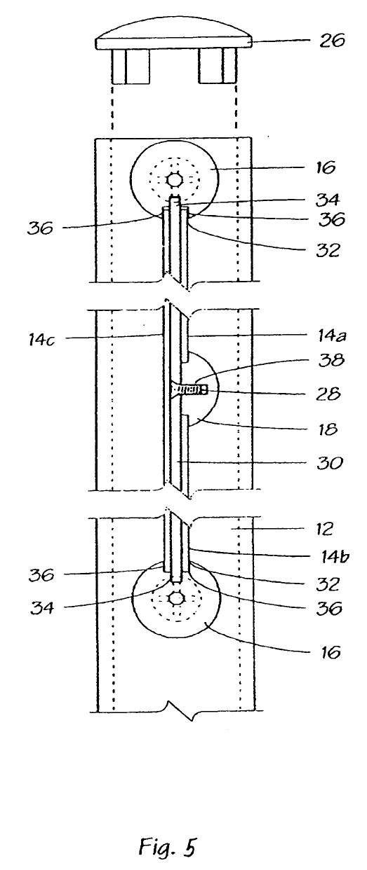

The left side of FIG. 5 shows a sign panel 14c which spans the full distance between the upper retaining rail 16a and the lower retaining rail 16b. The sign panels 14a, 14b, and 14c are substantially non-flexible, planar elements, which may be aluminum plates, aluminum plates with applied durable graphic surface material, 16 gauge steel plate with a non-conductive surface, embedment fiberglass sheet, high pressure laminate (i.e., melamine/phenolic panels), porcelain enamel panels of suitable strength, or other suitable planar materials. The panels are preferably weather resistant and capable of resisting localized surface impact. The right side of FIG. 5 shows two sign panels 14a, 14b, one mounted above the other. The bottom end of the upper sign panel 14a and the top end of the lower sign panel 14b are held against the core 30 by a center retaining bracket 18. The center retaining bracket 18 has a central channel 28, in which a threaded fastening device 38 is received for holding the center bracket 18 against the core 30, which is precision drilled for receipt of the center retaining bracket 18. One or more of the threaded fastening devices 38 may be used to hold the center bracket 18 against the core 30, which is precision drilled for receipt of the center retaining bracket 18.

Since the core 30 is held in the center portion 34 of the channel 32, the same rails 16, bracket 18, and core 30 may be used in signs requiring a sign panel 14-14c on only one side of the core 30 and in signs that require sign panels 14 on both sides of the core 30.

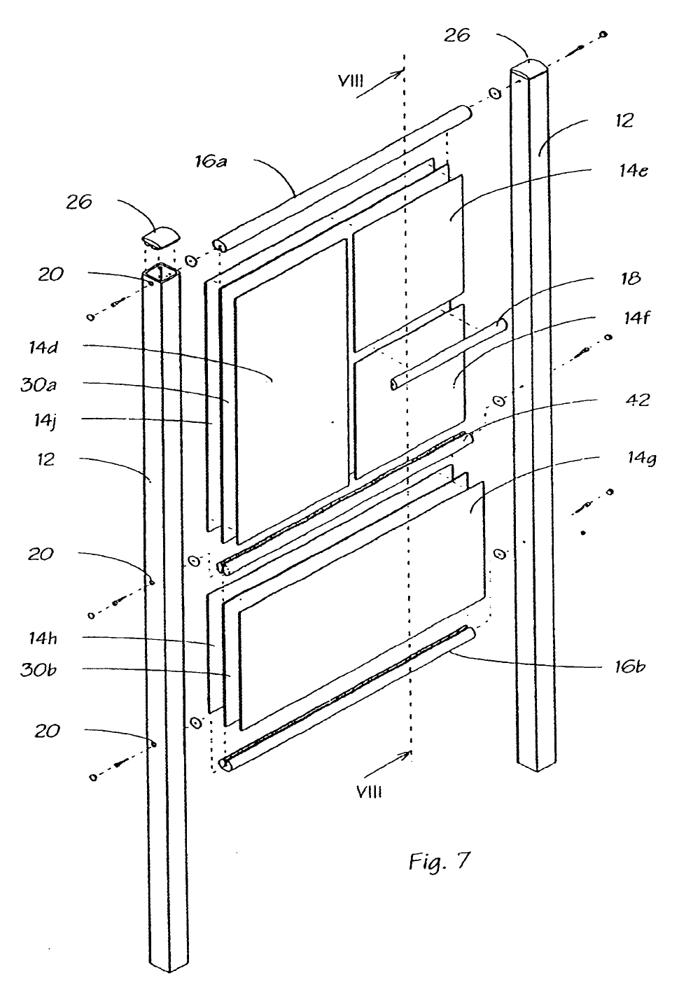

In some cases, where a larger sign area is required, a core 30 covering the entire sign area may exceed the appropriate lateral rigidity and not have structural integrity as a continuous member. In such cases, the core 30 is prone to warpage due to pressure applied by wind and other natural forces and/or deliberate destructive force. In such cases, a center retaining rail 42, as shown in FIGS. 7 and 8, may be used to connect two cores 30a and 30b. The center retaining rail 42 is connected between the two vertical uprights 12 similarly to the retaining rails 16a and 16b. The center retaining rail 42 holds the bottom of an upper core 30a and the top of a lower core 30b, thereby providing an additional central support for the large sign area. Each of the upper and lower cores 30a and 30b may include one or more rows and columns of sign panels 14, as described earlier with respect to core 30. For example, FIG. 7 shows that the front of core 30a has a first column including sign panel 14d on the left hand side which spans the entire height of the core 30a and a second column having two rows of sign panels 14e and 14f separated by center retaining bracket 18.

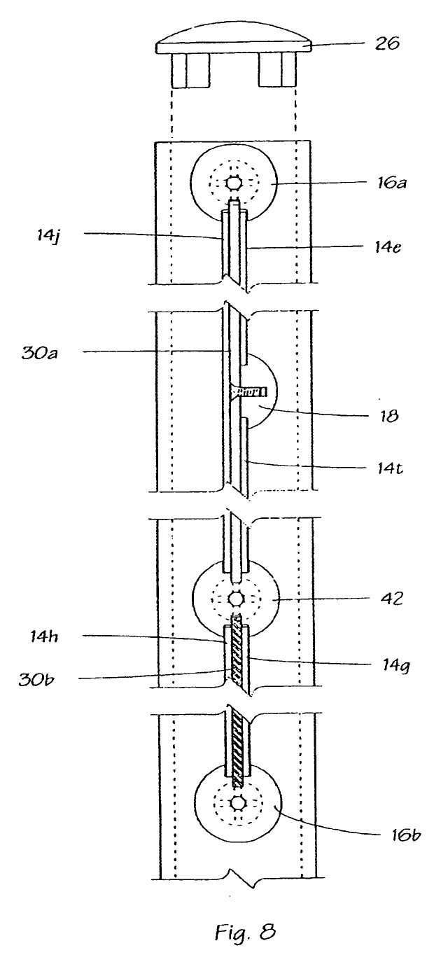

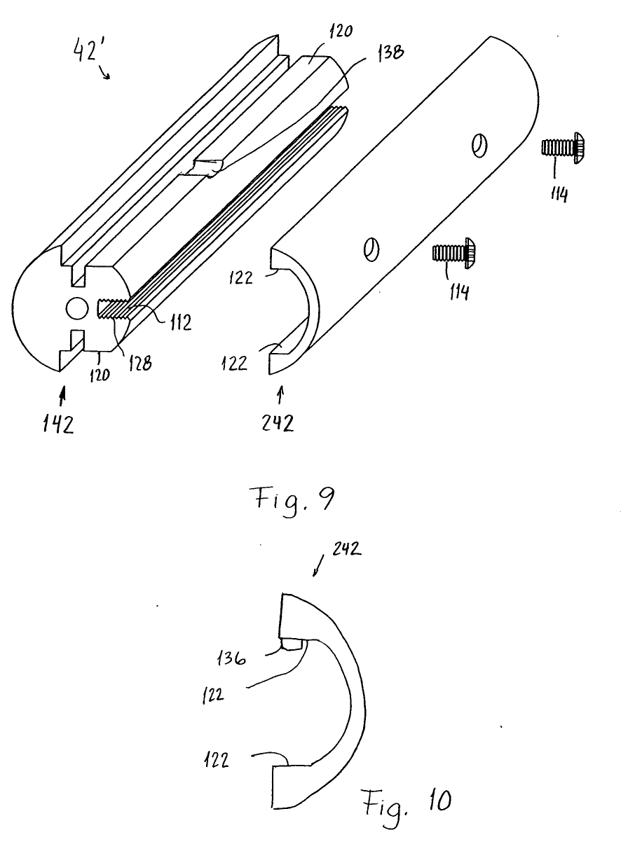

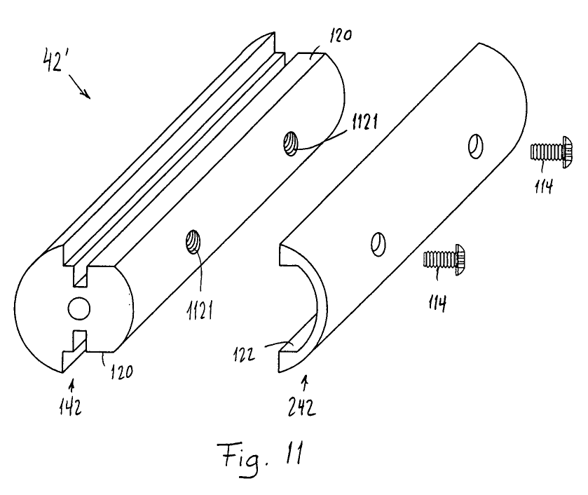

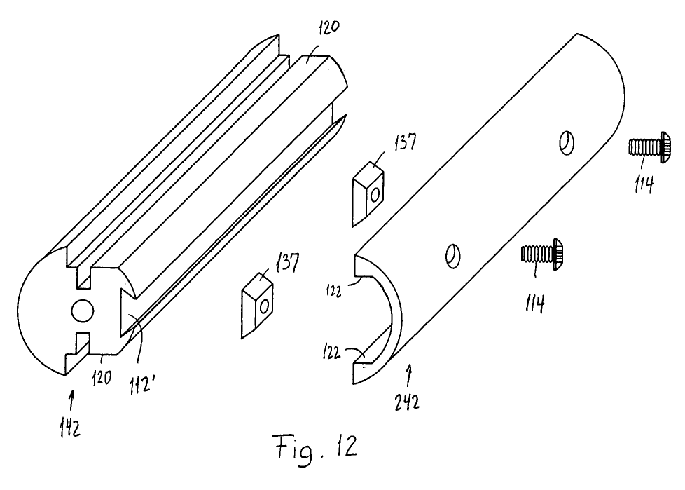

In the embodiments of FIGS. 1-8, at least one sign panel may be required to be changed on a periodic basis, e.g., for seasonal changes in a graphic display or to include updated information. To facilitate changing of the sign panels 14 in the embodiment of FIGS. 7 and 8 without removal of one of the retaining rails 16a, 16b, the center retaining rail 42 may be constructed in accordance with FIGS. 9 and 10. According to this embodiment, center retaining rail 42′ includes a base rail 142 and a face plate 242. The base rail 142 is connected between the vertical uprights 12 as described above. The base rail 142 has a central channel 112 in which threaded fasteners 114 are received for holding the face plate 242 onto the base rail 142. The central channel 112 has ridges 128 which extend longitudinally along the walls of the central channel 112 at a pitch and spacing corresponding to the pitch and thickness of the threaded fasteners 114. The ridges act as threads which receive the threaded fasteners 114 at any point along the channel 112. Instead of a channel 112, the base rail 142 may have threaded bore holes 1121 that correspond to the attachment points for the threaded fasteners 114 in face plate 242 as shown in FIG. 11. FIG. 12 shows a further alternative in which the base rail 142 includes a dove tail-shaped channel 112′. This channel 112′ may receive correspondingly-shaped connection elements 137, each having a threaded hole for respectively receiving the threaded fasteners 114.

As shown in FIGS. 9 and 10, the face plate 242 has a section profile to match the outer section profile of the opposite side of the central retaining rail 42 so that the central retaining rail aesthetically matches the section profile of the other retaining rails 16a, 16b, thereby providing a uniform appearance for each of the retaining rail 16a, 16b and the central retaining rail 42 over the facade of a complete assembly. The depth of the channel 112 is designed so that it is large enough to adequately engage threaded fasteners 114 while at the same time being limited so that the difference in strength between the center retaining rail 42′ and the center retaining rail 42 without a face plate is minimized. Accordingly, the center retaining rail 42′ has similar performance characteristics to center retaining rail 42 with respect to resistance to natural and deliberate destructive force. The depth of channel 112 may be limited so that the blind end of the channel 112 does not overlap the space between the channels 32.

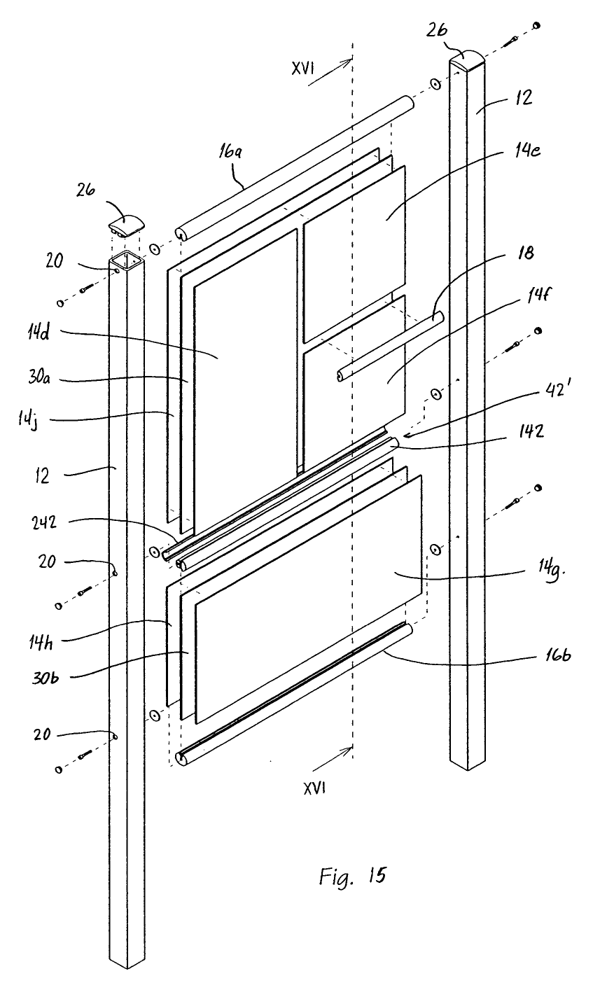

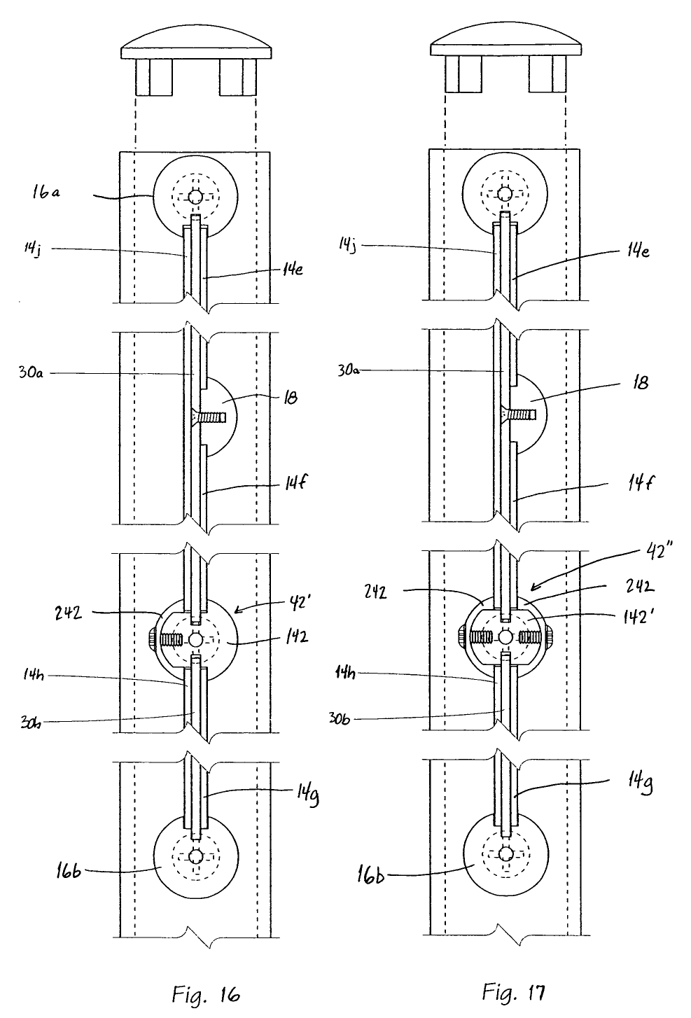

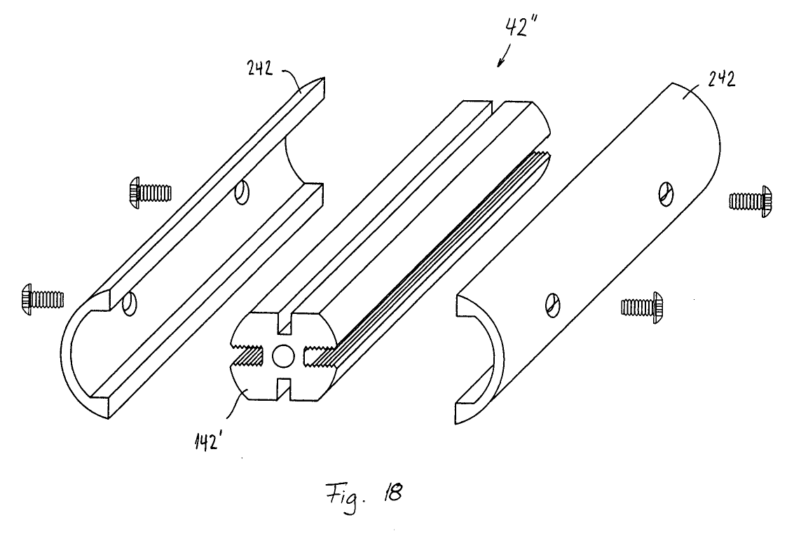

When the face plate 242 is received on the base rail 142, the channel 32 is defined as described above, wherein the face plate 242 defines an outer or external side of the side portions 36a of the channel 32. FIGS. 15 and 16 show a sign similar to the sign of FIGS. 7 and 8 with the center rail 42′ of FIG. 9. Sign panels 14j and 14h are readily removable from the sign of FIGS. 15 and 16 when the face plate 242 is removed from base rail 142. After the sign panels 14j and 14h are removed, retaining bracket 18 may also be removed to allow removal of sign panels 14e and 14f, if required. As a further alternative, FIGS. 17 and 18 show a sign in which a center rail 42″ includes face plates 242 on both sides, thereby allowing sign panels on both sides of the sign to be easily removed.

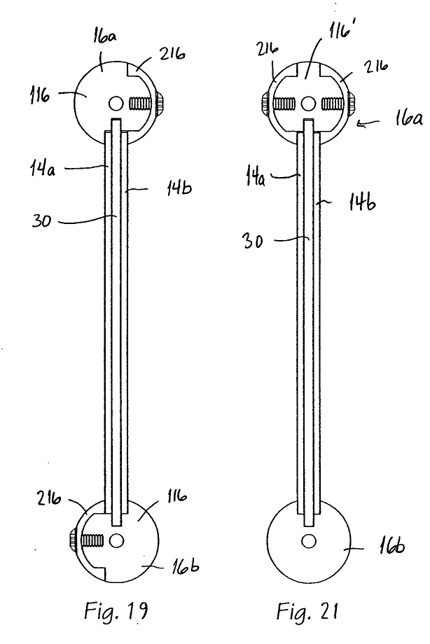

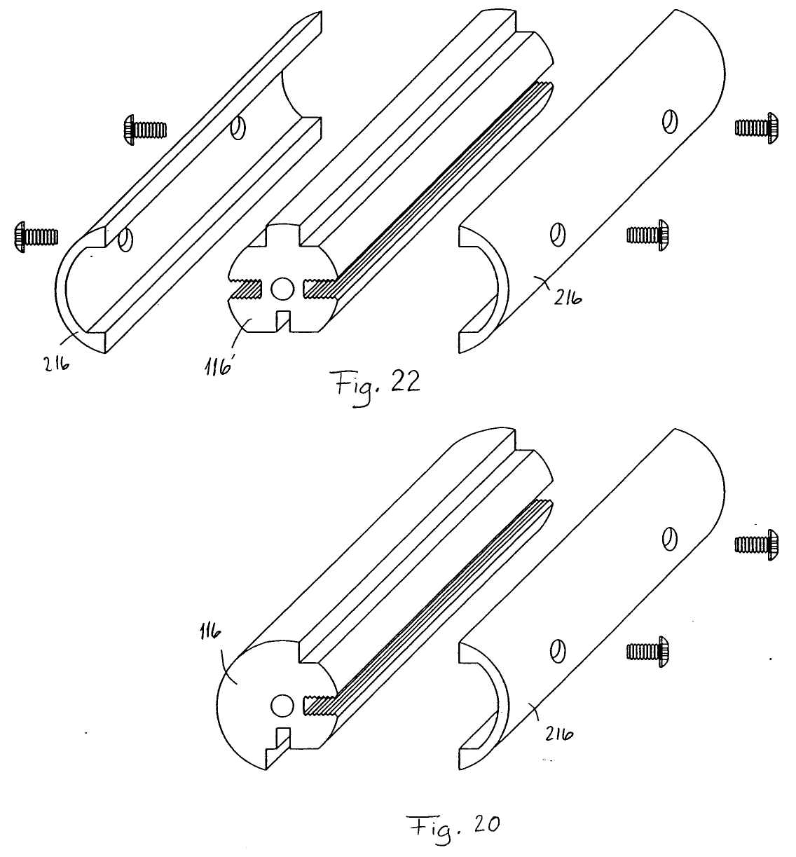

FIGS. 19 and 20 show yet another embodiment of the present invention including an upper retaining rail 16a and a lower retaining rail 16b. In this embodiment there is one core 30 and one sign 14a, 14b on each side of the core 30. Since there is no center retaining rail 42 in this embodiment, the upper and lower retaining rails include face plates 216. Face plates 216 are similar to the face plates 242 described above with respect to the center rail 42. The base rail 116 of the upper and lower rails 16a, 16b includes only one channel 32. To ensure that both signs can be easily removed, the face plate 216 of the upper retaining rail 16a is arranged on the left side for holding the sign panel 14b and the face plate 216 of the lower retaining rail 16b is arranged on the right side for holding the sign panel 14a. Therefore, the configuration shown in FIGS. 19-20 allows each of the sign panels 14a and 14b to be removed by removing the faceplate 216 while the base rail 116 remains connected to the vertical uprights 12. FIGS. 21-22 show an alternative embodiment in which two face plates 216 are arranged on opposing sides of a base rail 116′.

Although the stops 35 are shown in FIG. 6 as being formed by the stepped channel 32, other types of stops 35 may also be used. For example, FIG. 13 shows an upper rail 16a having a channel 32 which is partitioned into three separate and discrete portions, i.e., the center portion 34 and two side portions 36. In this embodiment, the core is positioned and held in the center portion 34 by partitions 35′.

In yet another embodiment shown in FIG. 14, the channel 32 comprises one continuous width and depth. An edge piece 35″ is connected to the end of the core 30 and is inserted into the channel 32. The edge piece 35″ has substantially the same width. W_{T} as the channel 32. The depth de of the edge piece 35″ is less than the depth d_{c} of the channel 32. Therefore, in this embodiment, the side channels 36 are formed between the core 30 and the sides of the channel 32 because the edge piece 35″ maintains the core 30 at the center of the width of the channel 32. The face plates 216 and 242 described above may be used with any of retaining rails shown in FIGS. 6, 13, and 14.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. For example rails 16 may be hollow (hollowed) extrusions withouth changing the functionality. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A sign system, comprising:
two laterally spaced vertical supports;
an upper rail and a lower rail, each extending between and connected to said laterally-spaced vertical supports, said upper rail and said lower rail each having a longitudinal groove running substantially along the longitudinal lengths of said upper rail and said lower rail, said longitudinal grooves of said upper rail and said lower rail being in a confrontingly opposed arrangement, each of said longitudinal grooves having a central portion with a length and lateral sides and side portions extending along the lateral sides of said central portion such that inner sides of said side portions face said lateral sides of said central portion and external sides of said side portions face away from said lateral sides of said central portion; and
a substantially planar core piece having upper and lower ends respectively releasably received in said central portions of said longitudinal grooves so that said core piece is held between said upper and lower rail, wherein
one of said upper and lower rails comprises a first face plate releasably connected thereto, said first face plate defining said external side of one of said side portions of said longitudinal groove of said one of said upper and lower rails when said first face plate is connected to said one of said upper and lower rails, and lateral access to said one of said side portions normal to said planar core piece is provided when said first face plate is disconnected from said one of said upper and lower rails.

2. The sign system of claim 1, wherein said first face plate is connected to said one of said upper and lower rails by threaded fasteners.

3. The sign system of claim 2, wherein said one of said upper and lower rails comprises threaded holes for receiving said threaded fasteners.

4. The sign system of claim 2, wherein said one of said upper and lower rails comprises a continuous threaded groove for receiving said threaded fasteners.

5. The sign system of claim 2, wherein said one of said upper and lower rails comprises a continuous channel for receiving a connector element for threadably receiving said threaded fasteners.

6. The sign system of claim 1, wherein a first surface of said first face plate slides over a second surface of said one of said upper and lower rails during connection of said first face plate so that said first face plate is properly aligned with said one of said upper and lower rails when it is received thereon.

7. The sign system of claim 6, wherein said second surface extends in a direction normal to said core piece.

8. The sign system of claim 6, further comprising one of a projection and a depression on said second surface corresponding to the other of a projection and a depression on said first surface.

9. The sign system of claim 1, further comprising a second face plate connected to said one of said upper and lower rails, wherein said second face plate defines said external side of the other one of said side portions of said longitudinal groove of said one of said upper and lower rails when said second face plate is connected to said one of said upper and lower rails, and lateral access to said other one of said side portions normal to said planar core piece is provided when said second face plate is disconnected from said one of said upper and lower rails.

10. The sign system of claim 1, wherein said one of said upper and lower rails is a central rail and comprises upper and lower grooves, said longitudinal groove being one of said upper and lower grooves, the other of said upper and lower grooves also having a central portion with a length and lateral sides and side portions extending along the lateral sides of said central portion such that inner sides of said side portions face said lateral sides of said central portion and external sides of said side portions face away from said lateral sides of said central portion, wherein said first face plate defines said external side of one of said side portions of each of said upper and lower longitudinal grooves of said one of said upper and lower rails when said removable face is connected to said one of said upper and lower rails, and lateral access to said one of said side portions of said each of said upper and lower longitudinal grooves normal to said planar core piece is provided when said first face is disconnected from said one of said upper and lower rails.

11. The sign system of claim 10, further comprising a further comprising a second face plate connected to said one of said upper and lower rails, wherein said second face plate defines said external sides of the other side portions of said upper and lower longitudinal grooves of said one of said upper and lower rails when said second face plate is connected to said one of said upper and lower rails, and lateral access to said other side portions normal to said planar core piece is provided when said second face plate is disconnected from said one of said upper and lower rails.
